(19) United States
(12) Patent Application Publication
(10) Pub. No.: US 2012/0094255 A1
(43) Pub. Date: Apr. 19, 2012

(54) Palate-Free Upper Denture

(76) Inventor: David Brown, Oakville (CA)

(21) Appl. No.: 12/903,239

(22) Filed: Oct. 13, 2010

(51) Int. Cl. A61C 13/007; A61C 13/23; A61C 13/225

(52) U.S. Cl. 433/180; 433/172; 433/200.1

(57) ABSTRACT

A palate-free upper denture comprising a denture base formed of an acrylic resin having (i) a lower portion bearing a plurality of downwardly protruding teeth; (ii) an upper portion defining an upper surface so shaped as to receive in retentive intimate engagement complementary peripheral gingiva portions of the upper mouth; and (iii) a lightweight metallic mesh embedded in said acrylic resin and usable in an amount to allow of satisfactory retention. The denture overcomes prior art drawbacks by allowing significant reduction in the amount of acrylic needed while providing sufficient structural integrity and acceptable upper denture retention.

### FIELD OF THE INVENTION

This invention relates to dentures that are used to replace teeth that are lost due to age, accident, diseases or other reasons. In particular, to the traditional upper denture having a full palate modified to an upper denture without a palate.

### BACKGROUND OF THE INVENTION

The loss of teeth can lead to speech and eating impairment. Significant tooth loss is considered a social stigma in a culture which places an emphasis on a smile with a full set of white teeth. As a result, the dental profession for centuries has worked to develop dental systems that replace lost teeth of its patients with a prosthesis which takes up the main functions of eating and aiding in talking, as well as the actual appearance of the lost teeth.

The tireless efforts of the dental profession have given rise to three well-accepted methods for tooth replacement. Two of these methods, namely, the denture, i.e. removable prosthesis method and the bridge, i.e. non-removable prosthesis method, have been in use for a long time. These methods are similar in that they both utilize tooth replacement prosthesis to address only the replacement of a part of the missing tooth, namely the exposed portion of the tooth known as the crown.

The denture is a removable dental prosthesis which has artificial teeth imbedded in a denture base resembling the gum or gingiva of the mouth. The denture base provides the support for the prosthesis by resting on the gingiva. The underside or upper surface of the denture base is suitably shaped in having a depression receptacle that receives at least a portion of the gingiva so as to provide a snug, reversible fit of the denture to the gingiva.

The denture is either a partial denture in being only a replacement for a few teeth or a full denture in replacing an entire set of teeth. A full denture replaces the lower set of teeth (“lower denture”) or upper set of teeth (“upper denture”). With the traditional full upper denture, the surface of the depression receptacle base adheres to the appropriate complementary gingiva surface of the denture wearer by saliva from the wearer's mouth causing a vacuum or suction between the surface of the depression receptacle and the mucus membranes of the gingiva on the gums and palate of the wearer's mouth. In the case of partial dentures, without a back molar anchor tooth to place a clasp they are often reversibly secured to the gingiva through the use of specially designed denture adhesives that are applied to the gingiva and the depression receptacle for that purpose.

A bridge prosthesis is similar to that of a denture prosthesis except the bridge is normally limited to being a partial denture which is non-reversibly cemented or otherwise affixed to the adjacent teeth.

The third and latest method for tooth loss replacement is the system of dental implants otherwise known as dental implantology. This field addresses the loss of the entire tooth including the root which is the anchoring and weight bearing structure for the tooth.

Dental implantology embeds an artificial implant into the jawbone of the patient to replace or supplant the root of the patient's missing teeth. These implants come in a wide variety of shapes, sizes, designs and compositions.

Full upper dentures having a full artificial palate in use create unsatisfactory situations. For example, the artificial palate does not allow the tongue of the wearer to feel the roof of the mouth but only the acrylic or metal material of which the denture palate is typically made.

The dental palate may cause somewhat impaired speech by its presence, can reduce oxygen access to the skin of the mouth palate and reduce skin freshness and also impair the taste of food by the mouth palate. Further, there is also the possible occurrence of developing sores and lesions on the palate and tongue by overextended use or shifting of the denture during mastication. Yet further, it is also desirable that the wearer feels he or she is more simulating the wearing of natural teeth by having reduced amounts of metal or plastics material in the mouth.

Still yet further, it will be readily understood that the avoidance of the need for a dental implant system with its significant expense, pain, potential surgical complications and avoiding a lengthy surgical and recovery process would be greatly appreciated by denture wearers.

Accordingly, there is a need for an improved upper denture that does not suffer from the aforesaid drawbacks.

Surprisingly, the applicant discovered that use of new lightweight materials metal in the form of a mesh design in an acrylic base or matrix allows a significant reduction in the amount of acrylic needed while providing sufficient structural integrity, longevity and acceptable upper denture retention.

It is crucial for adequate dental retention that the metal mesh is formed of new lightweight materials available to the industry, preferably Vitallium2000™ material, Titanium or any other suitably lightweight materials.

### SUMMARY OF THE INVENTION

In one aspect, the invention provides a palate-free upper denture comprising a denture base formed of an acrylic resin having (i) a lower portion bearing a plurality of downwardly protruding teeth; (ii) an upper portion defining an upper surface so shaped as to receive in retentive intimate engagement complementary peripheral gingiva portions of the upper mouth; and (iii) a lightweight metallic mesh embedded in said acrylic resin and usable in an amount to allow of satisfactory retention.

Preferably, the metal is titanium.

The upper surface of the base is formed by means of a molding process from a mold taken of the complementary gingiva portion.

In preferred embodiments, dentures as hereinabove defined, further comprise a suitably shaped and denture strengthening metallic strip bonded to the base at and protruding from a peripheral portion of the upper surface for abutment with the complementary peripheral gingiva portions.

Preferably the base or matrix is formed of an acrylic resin, which embraces the metallic mesh to provide additional strength.

The dentures, as hereinabove defined, may also be used with any suitable dental adhesive to provide enhanced retention on the gingiva as to provide the wearer with confidence that the denture will stay in place, particularly, in the event of, for example, sneezing, coughing or the eating of foods that are tough to bite, such as apples.

In a further aspect, the invention provides a method of making a palate-free upper denture comprising forming the so-shaped upper surface of the base complementary to implant-free said peripheral gingiva portion of the upper mouth.

Thus, the applicant has found that contrary to the prior art, an implant-free and/or palate-free denture, according to the invention, can be made and used with confidence by a wearer and does not suffer from the aforesaid drawbacks.

### BRIEF DESCRIPTION OF THE DRAWINGS

In order that the invention may be better understood, a preferred embodiment will now be described, by way of example only, with reference to the accompanying drawings wherein

FIG. 1 is a diagrammatic perspective view of an upper denture according to the prior art;

FIG. 2 is a diagrammatic perspective view of an upper denture according to the invention;

FIG. 3 is a vertical cross-section 3-3′ of the denture shown with reference to FIG. 2; and wherein the same numerals denote like parts.

### DETAILED DESCRIPTION OF PREFERRED EMBODIMENTS

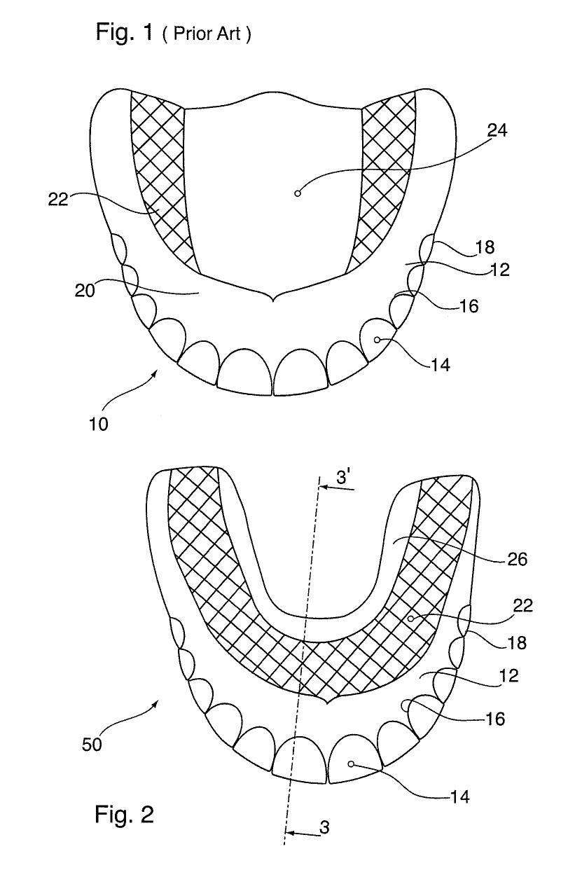

FIG. 1 shows generally as 10 an upper denture having an acrylic denture base 12 having a plurality of teeth 14 embedded therein at a lower portion 16 of base 12 and protruding from lower surface 18. Base 12 at its upper portion 20 has peripheral portion 22 defining a gingiva-receiving depression so shaped as to receive a complementary shaped portion of the gingiva of a wearer (not shown) in intimate abutment. Integrally formed with peripheral portion 22 is an artificial palate 24 of suitable shape and thickness as to abut the roof of the wearer's mouth in intimate engagement. Saliva in the wearer's mouth on installation of the denture causes a vacuum/suction between the surface of peripheral portion 22 and the mucous membranes of the gingiva on the gums and wearer's mouth. To enhance retention of the denture, a dental adhesive is applied to the gingiva prior to the installation of the denture thereon.

FIG. 2 shows generally as 50 a palate-free upper denture having denture base 12, teeth 14, lower base portion 16, lower surface 18, upper portion 20 and gingiva receiving depression at peripheral portion 22.

Embedded within and protruding from base peripheral portion 22 at upper portion 20 is a denture strengthening metallic strip 26 so suitably shaped as to also abut adjacent complementary peripheral gingiva portion of the wearer.

Base 12 is formed of an acrylic resin having an embedded metallic mesh to provide enhanced strength thereto.

Strip 26 protrudes to a suitable distance of about 1-5 mm from peripheral portion 22.

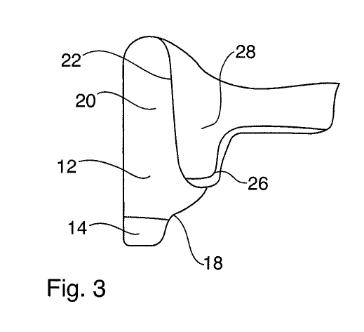

FIG. 3 shows depression 28 defined by peripheral surface 22 of base 12 at upper portion 20. Embedded within and inwardly protruding around upper portion into a wearer's mouth for about 1-5 mm. is a metal strip 26 for abutment with complementary portions of the gingiva.

Palate-free upper denture 10 can be made in the standard manner for a mesh-embedded acrylic denture base made from a mold taken of the gingiva, but wherein an artificial palate is absent. A metal strip 26 is suitably shaped and located as to be embedded in peripheral portion 22 by means of the acrylic resin.

This method is, thus, in contrast to the preparation of an upper denture for use with an implant, wherein a mold is taken of the combined gingiva-implant surface as well as the method for preparing a full artificial denture of the prior art.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. A palate-free upper denture comprising a denture base formed of an acrylic resin having (i) a lower portion bearing a plurality of downwardly protruding teeth; (ii) an upper portion defining an upper surface so shaped as to receive in retentive intimate engagement complementary peripheral gingiva portions of an upper mouth; and (iii) a lightweight metallic mesh embedded in said acrylic resin and usable in an amount to allow of satisfactory retention, and (iv) a suitably shaped and denture strengthening metallic strip bonded to said base at and protruding from a peripheral portion of said upper surface for abutment with said complementary peripheral gingiva portions, without the metallic strip being constructed and arranged to mechanically connect the denture to jaw bone.

2. A denture as claimed in claim 1 wherein said metallic mesh is titanium.

3. A denture as claimed in claim 1 wherein said upper surface of said base is formed by means of a molding process from a mold taken of said complementary gingiva portions.

4. (canceled)

5. A denture as claimed in claim 1 operably usable with a suitable adhesive for enhanced retention with said gingiva.

6. A method of making a palate-free upper denture as defined in claim 1 comprising forming said so-shaped upper surface of said base complementary to implant-free said peripheral gingiva portions of said upper mouth.

7. A method of making a palate-free upper denture as defined in claim 2 comprising forming said so-shaped upper surface of said base complementary to implant-free said peripheral gingiva portions of said upper mouth.

8. A method of making a palate-free upper denture as defined in claim 3 comprising forming said so-shaped upper surface of said base complementary to implant-free said peripheral gingiva portions of said upper mouth.

9. A method of making a palate-free upper denture as defined in claim 4 comprising forming said so-shaped upper surface of said base complementary to implant-free said peripheral gingiva portions of said upper mouth.
